(19) United States
(12) Patent Application Publication
(10) Pub. No.: US 2003/0030659 A1
(43) Pub. Date: Feb. 13, 2003

(54) Method of automatic display of audio-video films in web pages

(76) Inventor: Hsiang Min Wu, Taipei City (TW)

Correspondence Address: Hsiang Min Wu, PO Box 82-144, Taipei, TW

(21) Appl. No.: 09/925,497

(22) Filed: Aug. 10, 2001

(51) Int. Cl. G09G 5/00

(52) U.S. Cl. 345/716

(57) ABSTRACT

The present invention relates to automatic display of audio-video film in a web page, and in particular, automatic and repeated playing of a film in the course of browsing a web page without re-downloading of a player program or a film from the Internet. The Internet will automatically check whether a player program is present in the computer. Internet users do not have to concern whether there is a presence of audio-video player software in their computers. After the film data has been loaded in that particular computer, no re-downloading is required. In addition, if the audio-video film is downloaded to a data folder of a disk and then is executed, the quality of the film is ensure. Image freezing or a cut-off of signal is avoided in this case. If at different web sites, and at different web pages, the instruction to play the same film is found, the computer will directly execute the film from the stored disk without the re-download process. Therefore, this method of the present invention provides a direct playing function.

### BACKGROUND OF THE INVENTION

(a) Field of the Invention

The present invention relates to automatic display of audio-video film in a web page, and in particular, automatic and repeated playing of a film in the course of browsing a web page without re-downloading of a film from the Internet.

(b) Description of the Prior Art

After its development, Internet has been widely used in everywhere in the world and in all aspects of life.

The major function of Internet is the two-way trasmission of text data, image data, and audio-video films. Internet has emerged to be a very important broadcasting media.

Recently, web page with audio-video film is growing very fast and has attracted large amount of users. However, there are of two types of web audio-video film player programs commonly found in the market, that is the MediaPlayer (MP) and the RealPlayer (RP) and the operation of these two types are as follows

(A) MediaPlayer (MP):

When a linkage of an audio-video film in the web page is clicked or a web page with an audio-video is clicked, the MP program will start downloading data of the film from the Internet server to the computer of the user, and at the same time, the MP program in the computer will simultaneously start to receive the audio-video film data and directly execute the audio-video film

Real Player (RP):

In order to reduce the playing performance being affected by the unstable or poor transmission speed in he course of data downloading from the Internet, RP employs the method of first downloading a small portion of the film data to the RAM of the user's computer and then playing the film. Therefore, playing the audio-video film using the RP is improved.

However, these conventional playing programs have drawbacks as follows:

(A) Due to different band width of the Net user, the rate of data transmission is different. If the transmission speed is poor, and the transmission process is not stable, in playing the film by the MP or RP programs, freezing of picture or distorted signals will occur. Even though RP reserves a small portion of audio-video film by the program, the buffering is exhasted very soon when the Internet transmission speed is insufficient. Freezing of picture or distored signals also occur. Thus, the mood of enjoying the film from the Net is affected.

(B) If the user wants to view the film which has been previously played, the data has to be re-downloaded again. Thus, it is a waste of time and Internet bandwidth cost.

(C) If a user does not install any one of the two player programs, nothing will be played or output on the display.

(D) If the user needs to wait for a long time in order to view an advertising film or a documentary program, the user may lose the interest or not have the patient to wait for the program to appear on the display. Thus the intention of the advertising film or the documentary program has not been truly conveyed to the users.

### SUMMARY OF THE INVENTION

Accordingly, it is an object of the present invention to provide a method of automatic display of audio-video film in web page, which mitigates the above drawbacks. The method comprises the following steps:

(A) Producing a compressed digital audio-video file such that the file is small, facilitating transmitting and minimizing the volume of web page data.

(B) User does not need to preinstall a player program. The Internet will automatically check whether a player program is present in the user's computer. A player program is automatically installed if the player program is absent from the computer.

(C) The loaded data of the audio-video film will be stored in a preset data folder prior to execution of the film. Therefore, picture freezing or signal distortion will not be occurred in the course of the audio-video display.

(D) If the user browses the same film in either a same web page or other web pages, the same file can be executed from the data folder without wasting time and cost to download the same file which will affect the sharing of band width of the Internet server. In other words, the playing of the film is direct.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the method of automatic and repeated display of audio-video filme in web page in accordance with the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

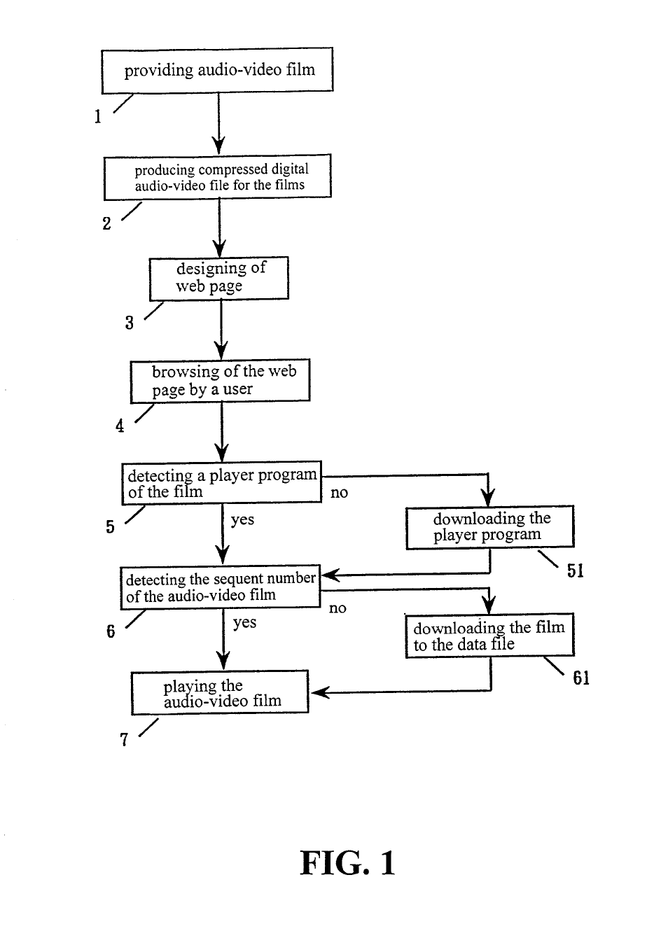

Referring to FIG. 1, there is shown a method of automatic and repeated display of audio-video film in web page and the method comprises the steps of: providing audio-video film (1) by enterprises, organizations, institutions, schools, professionals, advertisers, media operators by means of digital camera, video tape recorder or cam recorder with respect to commercial adverting film, movie preview, teaching movie, documentary preview, news, music TV; producing compressed digital audio-video file (2) for the films, web page designer designing of web page (3) with a space reserved for the display of the film or a linkage; browsing of the web page by a user (web surfer) (4); detecting a player program of the film (5), if not available, downloading automatically the player program (51), if available, detecting the sequent number of the audio-video film (6) to check whether the number is similar to that stored in the computer, if NO, downloading the film to the data file 61 of the computer disk if YES, playing the audio-video film (7).

In accordance with the present method, Internet users do not worry whether there is a presence or absence of audio-video player software in their computers. Once it was installed, no re-downloading is required. In addition, if the film is downloaded to a data folder of a disk and then is executed, the quality of the film is ensured. Therefore, the drawback of image freezing or a cut-off of signal is avoided. If at different web sites, and at different web pages, the instruction to play the same film is found, the computer will directly execute the film from the stored disk without the re-downloading process. Therefore, this method of the present invention provides a direct playing function.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A method of automatic display of audio-video film in web page comprising the steps of
(a) providing audio-video film (1) by enterprises, organizations, institutions, schools, professionals, media operators by means of digital camera, video tape recorder or cam recorder with respect to commercial advertising film, movie preview, teaching movie, documentary preview, news, music TV;
(b) producing compressed digital audio-video file (2) for the films, web designer;
(c) designing of web page (3) with a space reserved for display of the film or a linkage;
(d) browsing of the web page by a user (web surfer) (4);
(e) detecting the presence of a player program of the film (5), if NO, downloading automatically the player program (51), if YES,
(f) detecting the sequent number of the audio-video film to check whether the number is similar to that stored in the computer, if NO, downloading the film to the data file (61) of the computer disk, if YES,
(g) playing the audio-video film (7).
